(19) United States
(12) Patent Application Publication
(10) Pub. No.: US 2013/0286643 A1
(43) Pub. Date: Oct. 31, 2013

(54) LAMP COVER AND ILLUMINATION DEVICE USING THE SAME

(71) Applicants: CHIN-CHUNG CHEN, Tu-Cheng (TW); SHENG-JIE QIAO, Foshan City (CN); WEN XU, Foshan City (CN); MIN-CHI ZENG, Foshan City (CN); SHAN-YUE WANG, Foshan City (CN)

(72) Inventors: CHIN-CHUNG CHEN, Tu-Cheng (TW); SHENG-JIE QIAO, Foshan City (CN); WEN XU, Foshan City (CN); MIN-CHI ZENG, Foshan City (CN); SHAN-YUE WANG, Foshan City (CN)

(73) Assignees: FOXCONN TECHNOLOGY CO., LTD., Tu-Cheng (TW); CHAMP TECH OPTICAL (FOSHAN) CORPORATION, Foshan (CN)

(21) Appl. No.: 13/537,078

(22) Filed: Jun. 29, 2012

(30) Foreign Application Priority Data
Apr. 27, 2012 (CN) 201210127718.8

(51) Int. Cl. F21V 1/00; F21V 29/00

(52) U.S. Cl. 362/217.02; 362/235

(57) ABSTRACT

A luminous device comprises a light emitting diode (LED) light bar, a heat dissipating device thermally connected with the LED light bar, and a lamp cover made of light permissive material, engaging with the heat dissipating device and covering the LED light bar. The lamp cover is semicylindrical shaped and comprises an outer surface and an inner surface opposite to the outer surface and facing the LED light bar. A thickness of the lamp cover in a radial cross section thereof gradually reduces from a middle of the lamp cover to two opposite lateral sides thereof. Light generated by the LED light bar converges toward a plane orthogonally extending through the middle of the lamp cover after the light travels through the lamp cover.

### BACKGROUND

1. Technical Field

The present disclosure relates to a lamp cover, and more particularly, to a light emitting diode (LED) lamp cover and a luminous device using the lamp cover.

2. Description of Related Art

LEDs have been widely promoted as light sources of electronic devices owing to many advantages, such as high luminosity, low operational voltage and low power consumption. However, as a surface light source, due to poor convergence performance, a conventional LED tube which has an LED light bar enclosed by a lamp cover is not well enough to satisfy illumination requirements in special occasion where a high light intensity distribution is required.

Therefore, a lamp cover and a luminous device, i.e., an LED tube which has the lamp cover capable of overcoming the above described shortcomings are desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of a luminous device in accordance with an embodiment of the present disclosure.

FIG. 2 is an exploded view of the luminous device of FIG. 1.

FIG. 3 is a cross sectional view of a lamp cover of the luminous device of FIG. 2.

### DETAILED DESCRIPTION

Embodiment of the present lamp cover and luminous device will now be described in detail below and with reference to the drawings.

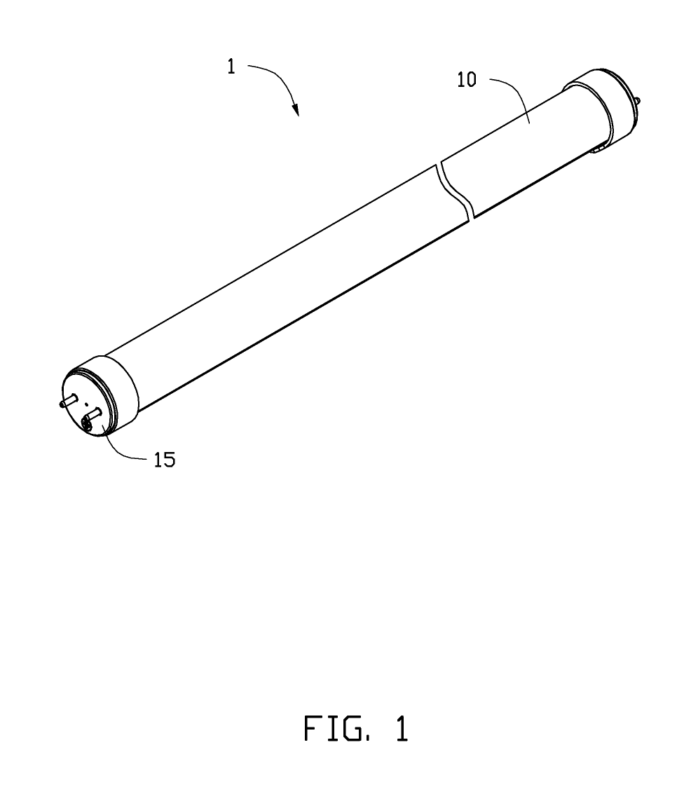

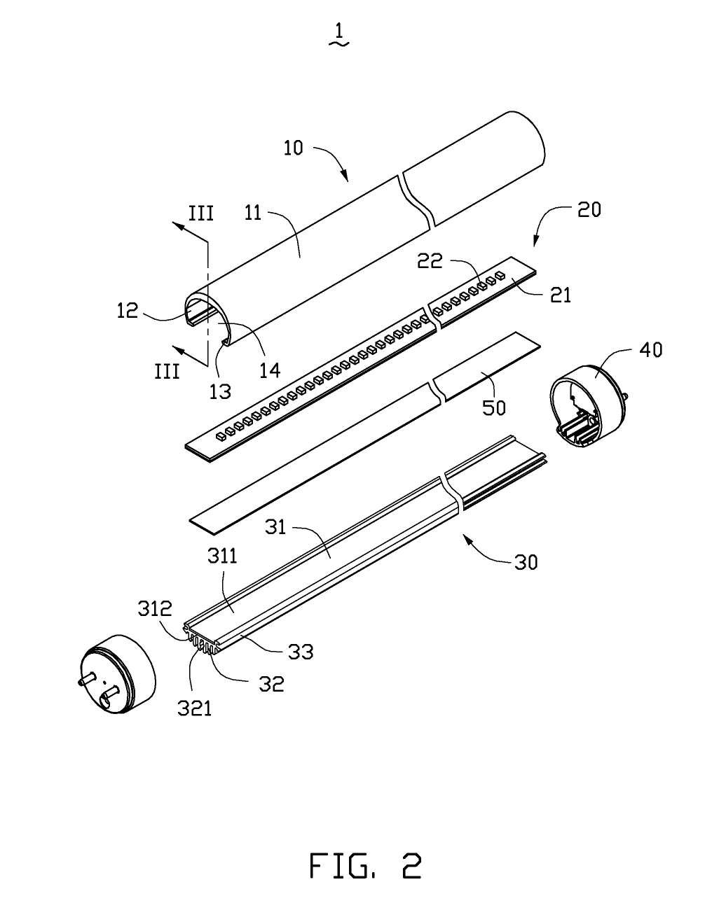

Referring to FIGS. 1 and 2, a luminous device 1, in accordance with an exemplary embodiment of the present disclosure, is shown. The luminous device 1 is an LED tube and includes a lamp cover 10, an LED light bar 20 received in the lamp cover 10, and a heat dissipating device 30 thermally connected to the LED light bar 20.

The lamp cover 10 is made of a light permissive material, such as silicone, resin, glass, polymethyl methacrylate (PMMA), quartz, polycarbonate (PC), epoxy, polyacrylate. In this embodiment, the lamp cover 10 is injection molded with plastic, particularly polymethyl methacrylate (PMMA) and a has a transparency exceeding 90%.

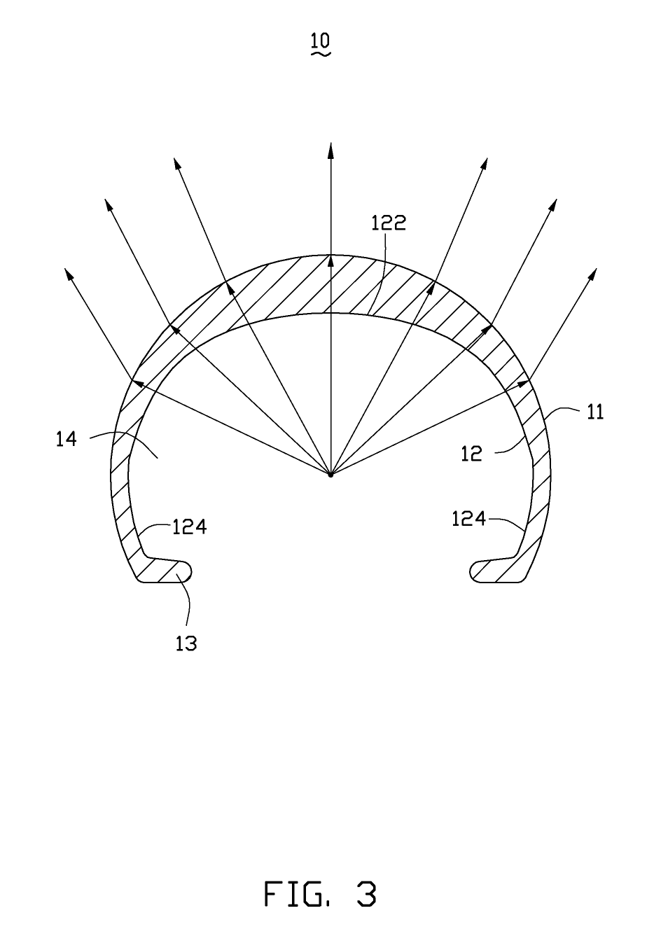

The lamp cover 10 is substantially semicylindrical, and has a substantially Cshaped radial cross section, thereby to define a receiving room 14 therein. Also referring to FIG. 3, the lamp cover 10 has an outer surface 11 and an inner surface 12 opposite to the outer surface 11. In this embodiment, a profile of the outer surface 11 in the radial cross section is semicircular, and a profile of the inner surface 12 in the radial cross section is divided into a middle section 122 extending over an angle of 120 degrees and two lateral sections 124 each extending over an angle of 30 degrees. The middle section 122 has an aspheric profile while each lateral section 124 has a profile of a part of a circumference of a circle which is concentric with the semicircle of the outer surface 11. The lamp cover 10 has a thickness in the radial cross section and over the range of the middle section 122 gradually reduces from a middle to lateral sides thereof. Preferably, the inner surface 12 of the lamp cover 10 is equipped with a diffusion plate with appropriate haze, which can reduce glare and granular sensation generated by the LED light bar 20. The lamp cover 10 further includes two engaging portions 13 respectively at two bottom ends in a length direction thereof, and the engaging portions 13 are used for engaging with the heat dissipating device 30. In this embodiment, the engaging portions 13 are plate shaped, and extend from bottom ends of the lateral sections 124 towards each other.

The LED light bar 20 includes a supporting plate 21 and a plurality of spaced light emitting elements 22 located on the supporting plate 21. The light emitting elements 22 are adhered on the supporting plate 21 by thermal conductive adhesive, and electrically connected to a circuit structure of the supporting plate 21 by wires, respectively. Alternatively, the light emitting elements 22 are directly mounted on the supporting plate 21 by surface mounting technology (SMT). The plurality of light emitting elements 22 can be LED packages or LED chips. The supporting plate 21 can be a circuit board, particularly a printed circuit board. The LED light bar 20 is received in the receiving room 14, and light emitted from the light emitting elements 22 is projected out of the illumination device 1 via the lamp cover 10, particularly via the middle section 122 of the inner surface 12 and a corresponding section of the outer surface 11.

The heat dissipating device 30 is made of high heat conductive materials, such as aluminum, and attached to the supporting plate 21 of the LED light bar 20. The heat dissipating device 30 includes a base 31 and a plurality of parallel fins 32 protruding downwardly from a bottom surface of the base 31 and axially extending along the base 31. The base 31 includes two locking portions 33 respectively at two lateral ends thereof, each extending over a length of the base 31. The locking portions 33 respectively match with and engagingly receive the engaging portions 13 of the lamp cover 10, thereby connecting the heat dissipating device 30 with the lamp cover 10. In this embodiment, the two locking portions 33 are grooves, respectively defined in opposite lateral sides of the base 31, each with an opening away from the base 31 for receiving the engaging portion 13 therein. The base 31 has an upper surface 311 and a bottom surface 312 opposite to the upper surface 311. The fins 32 are located on the bottom surface 312 of the base 31. Height of the fins 32 gradually reduces from a middle to lateral sides of the base 31 in a width direction, thereby to strengthen air convection and meet a heat distribution of the LED light bar 20.

Preferably, a silica gel layer 50 with high heat conductivity can be located between the supporting plate 21 of the LED light bar 20 and the upper surface 311 of the base 31. The silica gel layer 50 is used for closely interconnecting the LED light bar 20 with the heat dissipating device 30. Then, heat generated by the light emitting elements 22 of the LED light bar 20 can be transferred to the heat dissipating device 30 quickly. Therefore, the heat dissipating efficiency is improved.

The luminous device 1 further includes two connectors 40. The two connectors 40 are located at two opposite ends of the lamp cover 10 and the heat dissipating device 30 respectively, and used for electrically connecting the luminous device 1 with an external power supply via an LED tube fixture (not shown).

During operation of the luminous device 1, the light emitted from the light emitting elements 22 passes through the receiving room 14, incidents onto the lamp cover 10, and finally passes through the lamp cover 10 and travels outward. Due to that the thickness of the lamp cover 10 in a radial cross section thereof gradually reduces from a middle to lateral sides thereof, the light passing through the lamp cover 10 will be converged toward an axial plane of the luminous device 1 orthogonally extending through the middle of the lamp cover 10. Therefore, the convergence performance of the luminous device 1 is improved, and a brightness of a middle portion of the light field of the luminous device 1 is increased. The luminous device 1 has improved brightness in predetermined area without increasing the light emitting elements 22.

Particular embodiments are shown and described by way of illustration only. The principles and the features of the present disclosure may be employed in various and numerous embodiments thereof without departing from the scope of the disclosure as claimed. The abovedescribed embodiments illustrate the scope of the disclosure but do not restrict the scope of the disclosure.

What is claimed is:

1. A lamp cover used to cover an LED (light emitting diode) light bar of an LED tube, the lamp cover being made of a light permissive material and semicylindrical shaped, the lamp cover comprising an outer surface and an inner surface opposite to the outer surface and for facing the LED light bar, and the lamp cover having a thickness in a radial cross section thereof which is gradually reduced from a middle to two opposite lateral sides of the lamp cover, whereby light generated by the LED light bar is converged toward a plane orthogonally extending through the middle of the lamp cover after the light travels through the inner surface and then the outer surface of the lamp cover.

2. The lamp cover of claim 1, wherein the lamp cover is injection molded with plastic, and a transparency of the plastic is over 90%.

3. The lamp cover of claim 1, wherein a profile of the outer surface in the radial cross section is semicircular and a profile of at least a middle portion of the inner surface in the radial cross section is aspheric.

4. The lamp cover of claim 3, wherein the middle portion extends over an angle of 120 degrees.

5. A luminous device, comprising:
a plurality of light emitting elements;
a heat dissipating device thermally connected with the plurality of light emitting elements; and
a lamp cover made of a light permissive material, the lamp cover being semicylindrical shaped, the lamp cover comprising an outer surface and an inner surface opposite to the outer surface and facing the light emitting elements, and the lamp cover having a thickness in a radial cross section thereof which is gradually reduced from a middle to two opposite lateral sides thereof,
wherein the plurality of light emitting elements are received in the lamp cover, light emitted from the plurality of light emitting elements is projected out of the illumination device via the lamp cover, the light converging toward a plane orthogonally extending through the middle of the lamp cover after the light travels through the lamp cover.

6. The luminous device of claim 5, wherein the lamp cover is injection molded with plastic, and a transparency of the plastic is over 90%.

7. The luminous device of claim 5, wherein a profile of the outer surface in the radial cross section is semicircular and a profile of at least a middle portion of the inner surface in the radial cross section is aspheric.

8. The luminous device of claim 5 further comprising a supporting plate, the plurality of light emitting elements are spaced from each other and located on the supporting plate, and the supporting plate is thermally connected with the heat dissipating device.

9. The luminous device of claim 8, wherein a thermal conductive silica gel layer is located between the supporting plate and the heat dissipating device.

10. The luminous device of claim 8, wherein the plurality of light emitting elements are adhered on the supporting plate by thermal conductive adhesive.

11. The luminous of claim 8, wherein the plurality of light emitting elements are mounted on the supporting plate by surface mounting technology.

12. The luminous device of claim 5, wherein two engaging portions extend from the inner surface of the lamp cover, two locking portions are formed on the heat dissipating device, the engaging portions are engaged with the locking portions to connect the heat dissipating device and the lamp cover together.

13. The luminous device of claim 5, wherein the heat dissipating device comprises a base and a plurality of fins located on the base, and the plurality of light emitting elements are thermally connected with the base.

14. The luminous device of claim 13, wherein a height of the fins gradually reduces from a middle of the base to lateral sides thereof along a width direction of the base.
